(19) United States
(12) Patent Application Publication
(10) Pub. No.: US 2023/0411588 A1
(43) Pub. Date: Dec. 21, 2023

(54) FREE-STANDING ELECTRODE FILM MANUFACTURE USING HIGH PRECISION PRESS

(71) Applicant: LiCAP Technologies, Inc., Sacramento, CA (US)

(72) Inventors: Linda Zhong, Sacramento, CA (US); Martin Zea, Sacramento, CA (US); Eric Fodge, Sacramento, CA (US)

(21) Appl. No.: 18/240,089

(22) Filed: Aug. 30, 2023

Related U.S. Application Data
(63) Continuation-in-part of application No. 17/835,205, filed on Jun. 8, 2022.

(51) Int. Cl. H01M 4/04

(52) U.S. Cl. CPC H01M 4/0435; H01M 4/0471; H01M 4/0416

(57) ABSTRACT

A method of manufacturing a free-standing electrode film for an electrode of an energy storage device includes providing a powder mixture of at least one electrode active material and at least one fibrillizable binder and feeding the powder mixture to a mill line including one or more presses. At least one press may include a pair of opposing working rolls and a backing roll associated with each working roll. An apparatus for manufacturing a free-standing electrode film includes a mill line including at least one press having a pair of opposing working rolls and a backing roll associated with each working roll, a barrel of at least one of the backing rolls having a diameter that is at least 1.5 times a diameter of a barrel of the associated working roll, the barrels of the opposing working rolls each having a total indicated runout (TIR) of less than 5 μm.

### CROSS-REFERENCE TO RELATED APPLICATIONS

This application is a continuation-in-part of U.S. patent application Ser. No. 17/835,205, filed Jun. 8, 2022 and entitled “FREE-STANDING ELECTRODE FILM FOR DRY ELECTRODE MANUFACTURE,” the entire disclosure of which is hereby incorporated by reference.

### STATEMENT RE: FEDERALLY SPONSORED RESEARCH/DEVELOPMENT

Not Applicable

### BACKGROUND

### 1. Technical Field

The present disclosure relates generally to manufacturing energy storage devices such as Li-ion batteries and, more particularly, to dry processes for the manufacture of electrodes for energy storage devices.

### 2. Related Art

As demand for inexpensive energy storage devices increases, various methods have been proposed for manufacturing electrodes. Among these, there exist so-called “dry” processes by which a free-standing electrode film may be manufactured while avoiding the expense and drying time associated with the solvents and aqueous solutions that are typically used in slurry coating and extrusion processes. After a free-standing electrode film is produced, it is laminated to a current collector in order to produce an electrode. While these processes have been successfully applied in the ultracapacitor industry where the active materials are mainly activated carbon or other carbon-based materials, such as hard carbon, soft carbon, or graphite, there remain significant limitations and challenges when it comes to developing low-cost, high-quality, and high-speed production lines. The difficulties are especially pronounced when applying the same technology to the manufacture of battery electrodes, which are normally made from less flexible and less compressible materials such as lithium nickel manganese cobalt oxide (NCM), lithium cobalt oxide (LCO), lithium nickel cobalt aluminum oxide (NCA), lithium manganese oxide (LMO), lithium nickel manganese oxide (LNMO), lithium iron phosphate (LFP), lithium manganese iron phosphate (LMFP), other Lithium metal oxides, or silicon based anode materials. One of the main difficulties has been to produce a free-standing film having uniform thickness, especially in the area of battery electrodes, which must meet exceptional tolerance standards (e.g., +/−1 μm) for the manufacture of high-performance battery cells.

### BRIEF SUMMARY

The present disclosure contemplates various apparatuses and methods, as well as related products, for overcoming the above drawbacks accompanying the related art. One aspect of the embodiments of the present disclosure is an apparatus for manufacturing an electrode for an energy storage device. The apparatus may comprise at least one laminator for simultaneously laminating two free-standing electrode films on opposite sides of a current collector and a pair of mill lines operable to produce, respectively, the two free-standing electrode films and to feed the two free-standing electrode films simultaneously to the laminator. Each of the mill lines may comprise at least one first press including working rolls arranged horizontally for pressing a powder mixture into a respective one of the free-standing electrode films and at least one second press including working rolls (typically arranged vertically) for reducing the thickness of the respective free-standing electrode film.

The apparatus may comprise a mill line expansion module. The mill line expansion module may be insertable into a mill line of the pair of mill lines and may comprise at least one additional second press including working rolls (typically arranged vertically) for reducing the thickness of the respective free-standing electrode film. In general, the number of presses may be directly related to the final electrode film thickness, porosity, and density and the corresponding film mechanical strength such as breakage elongation and tensile strength, as well as the speed of the mill lines. By employing a modular system rather than having a fixed number of presses, the apparatus can tailor these parameters for various material types with different electrode specifications.

Each of the mill lines may comprise one or more conveyors arranged to support the respective free-standing electrode film as it is fed from the at least one second press of the mill line to the laminator. The one or more conveyors may be arranged to support the respective free-standing electrode film as it is fed from a first of the at least one second press to a second of the at least one second press of the mill line. A speed of the one or more conveyors between the at least one second press of the mill line and the laminator may be controlled to be different from a speed of the one or more conveyors between the first of the at least one second press and the second of the at least one second press of the mill line. The one or more conveyors may be arranged to support the respective free-standing electrode film as it is fed from the at least one first press to the at least one second press of the mill line. The speeds of the conveyor(s) between each stage, including between the first press and the first of the second press(es), between any adjacent second press(es), and between the second press(es) and the laminator, may be controlled to be different. Each of the mill lines may comprise one or more tension sensors arranged to measure a tension of the free-standing electrode film. A speed of the one or more conveyors of the mill line and/or a speed of the working rolls of the at least one second press of the mill line may be controlled based on the measured tension, e.g., to prevent film breakage. The one or more conveyors may comprise at least one vacuum conveyor.

Another aspect of the embodiments of the present disclosure is a method of manufacturing an electrode for an energy storage device. The method may comprise providing the above apparatus, preparing a first powder mixture including an electrode active material and a fibrillizable binder, fibrillizing the fibrillizable binder in the first powder mixture by subjecting the first powder mixture to a shear force, pressing the first powder mixture into a first free-standing electrode film using the at least one first press of a first mill line of the pair of mill lines, reducing the thickness of the first free-standing electrode film using the at least one second press of the first mill line, and laminating the first free-standing electrode film on a first side of a current collector using the at least one laminator.

The method may comprise preparing a second powder mixture including an electrode active material and a fibrillizable binder, fibrillizing the fibrillizable binder in the second powder mixture by subjecting the second powder mixture to a shear force, pressing the second powder mixture into a second free-standing electrode film using the at least one first press of a second mill line of the pair of mill lines, reducing the thickness of the second free-standing electrode film using the at least one second press of the second mill line, and, simultaneously with said laminating the first free-standing electrode film on the first side of the current collector, laminating the second free-standing electrode film on a second side of the current collector opposite the first side using the at least one laminator.

Another aspect of the embodiments of the present disclosure is a method of manufacturing an electrode for an energy storage device. The method may comprise preparing a first powder mixture including an electrode active material and a fibrillizable binder, fibrillizing the fibrillizable binder in the first powder mixture by subjecting the first powder mixture to a shear force, preparing a second powder mixture including an electrode active material and a fibrillizable binder, fibrillizing the fibrillizable binder in the second powder mixture by subjecting the second powder mixture to a shear force, and simultaneously producing a first free-standing electrode film from the first powder mixture and a second free-standing electrode film from the second powder mixture using a pair of mill lines, each of the mill lines comprising at least one first press including working rolls arranged horizontally for pressing the respective powder mixture into the respective free-standing electrode film and at least one second press including working rolls (typically arranged vertically) for reducing the thickness of the respective free-standing electrode film. The method may further comprise, continuously with said producing the first and second free-standing electrode films, feeding the first and second free-standing electrode films from the respective mill lines to a laminator and laminating the first and second free-standing electrode films on opposite sides of a current collector.

The method may comprise supporting the first free-standing electrode film using one or more conveyors as the first free-standing electrode film is fed from the respective mill line to the laminator. The method may comprise supporting the first free-standing electrode film using the one or more conveyors as the first free-standing electrode film is fed from a first of the at least one second press to a second of the at least one second press of the respective mill line. The method may comprise controlling a speed of the one or more conveyors between the respective mill line and the laminator to be different from a speed of the one or more conveyors between the first of the at least one first press and the second of the at least one first press of the respective mill line. The method may comprise supporting the first free-standing electrode film using the one or more conveyors as the first free-standing electrode film is fed from the at least one first press to the at least one second press of the respective mill line. The method may comprise controlling the speeds of the conveyor(s) to be different between each stage, including between the first press and the first of the second press(es), between any adjacent second press(es), and between the second press(es) and the laminator. The method may comprise measuring a tension of the first free-standing electrode film and controlling a speed of the one or more conveyors and/or a speed of the working rolls of the at least one second press based on the measured tension, e.g., to prevent film breakage. The one or more conveyors may comprise at least one vacuum conveyor.

Another aspect of the embodiments of the present disclosure is a free-standing electrode film. The free-standing electrode film may comprise an electrode active material and a fibrillizable binder. A machine direction elongation percentage of the free-standing electrode film may be less than 4%. The machine direction elongation percentage of the free-standing electrode film may be less than 2%. A machine direction tensile strength of the free-standing electrode film may be greater than 450 kPa. The porosity of the free-standing electrode film may be less than 32%.

Another aspect of the embodiments of the present disclosure is a method of manufacturing a free-standing electrode film for an electrode of an energy storage device such as a battery. The method may comprise providing a powder mixture of at least one electrode active material and at least one fibrillizable binder and feeding the powder mixture to a mill line including one or more presses to produce the free-standing electrode film. At least one of the one or more presses may include a pair of opposing working rolls and a backing roll associated with each working roll.

For at least one of the working rolls, a barrel of the associated backing roll has a diameter that is at least 1.5 times a diameter of a barrel of the working roll. The at least one of the one or more presses may further include at least one additional backing roll associated with each working roll. The at least one of the one or more presses may be arranged to reduce a thickness of the free-standing electrode film produced by the mill line. The at least one of the one or more presses may be arranged to press the powder mixture into the free-standing electrode film. The at least one of the one or more presses may be part of a mill line expansion module that is insertable into the mill line to increase the number of presses. The method may comprise controlling a surface temperature of respective barrels of the working rolls and backing rolls to have less than +/−3° C. variation across a length of each barrel during feeding. Controlling the surface temperature may comprise heating the respective barrels of the working rolls and backing rolls to be between 70° C. and 200° C. during feeding. The method may comprise, prior to feeding the powder mixture to the mill line, fibrillizing the fibrillizable binder in the powder mixture by subjecting the powder mixture to a shear force. The powder mixture may further include at least one additive containing solvent. The powder mixture may further include at least one dry electrolyte powder.

The method may comprise exerting a force on a respective journal of one or both of the opposing working rolls. The force may act so as to bend a lengthwise center of a barrel of the working roll toward the other working roll. The method may comprise taking one or more thickness measurements of the free-standing electrode film produced by the mill line. The force may be exerted based on the one or more thickness measurements.

The method may comprise exerting a force on a respective journal of one or both of the backing rolls. The force may act so as to bend a lengthwise center of a barrel of the backing roll toward the associated working roll. The method may comprise taking one or more thickness measurements of the free-standing electrode film produced by the mill line. The force may be exerted based on the one or more thickness measurements.

A barrel of at least one of the working rolls or at least one of the backing rolls may have a greater diameter at a lengthwise center of the barrel than at both lengthwise ends of the barrel.

The mill line may further include a plurality of heating elements arranged to heat respective lengthwise regions of a barrel of at least one of the opposing working rolls or at least one of the backing rolls. The method may comprise individually controlling the plurality of heating elements. The method may comprise taking one or more thickness measurements of the free-standing electrode film produced by the mill line. The plurality of heating elements may be individually controlled based on the one or more thickness measurements.

Another aspect of the embodiments of the present disclosure is a method of manufacturing an electrode of an energy storage device such as a battery. The method may comprise providing a powder mixture of at least one electrode active material and at least one fibrillizable binder and feeding the powder mixture to a mill line including one or more presses to produce a free-standing electrode film. At least one of the one or more presses may include a pair of opposing working rolls and a backing roll associated with each working roll. The method may further comprise laminating at least one free-standing electrode film produced by the mill line to a current collector.

The electrode may be a solid-state battery electrode. The powder mixture may further include at least one dry electrolyte powder.

Another aspect of the embodiments of the present disclosure is an apparatus for manufacturing a free-standing electrode film for a battery electrode. The apparatus may comprise a mill line including one or more presses. At least one of the one or more presses may include a pair of opposing working rolls and a backing roll associated with each working roll. A barrel of at least one of the backing rolls may have a diameter that is at least 1.5 times a diameter of a barrel of the associated working roll. The barrels of the opposing working rolls may each have a total indicated runout (TIR) of less than 5 μm.

The barrels of the opposing working rolls may be separated by a roll gap that is adjustable with better than 5 μm resolution. The barrels of the opposing working rolls may each have a surface finish of ISO N8 or smoother.

The at least one of the one or more presses may include at least one additional backing roll associated with each working roll. The at least one of the one or more presses may be arranged to reduce a thickness of the free-standing electrode film produced by the mill line. The at least one of the one or more presses may be arranged to press the powder mixture into the free-standing electrode film. The at least one of the one or more presses may be part of a mill line expansion module that is insertable into the mill line to increase the number of presses. A surface temperature of respective barrels of the working rolls and backing rolls may be controllable to have less than +/−3° C. variation across a length of each barrel. The surface temperature may be controllable to be between 70° C. and 200° C.

The apparatus may comprise one or more actuators operable to exert a force on a respective journal of one or both of the opposing working rolls, the force acting so as to bend a lengthwise center of a barrel of the working roll toward the other working roll. The apparatus may comprise a human machine interface for receiving user input. The force may be exerted based at least in part on the user input. The apparatus may comprise one or more thickness sensors operable to take one or more thickness measurements of the free-standing electrode film produced by the mill line. The force may be exerted based at least in part on the one or more thickness measurements.

The apparatus may comprise one or more actuators operable to exert a force on a respective journal of one or both of the backing rolls, the force acting so as to bend a lengthwise center of a barrel of the backing roll toward the associated working roll. The apparatus may comprise a human machine interface for receiving user input. The force may be exerted based at least in part on the user input. The apparatus may comprise one or more thickness sensors operable to take one or more thickness measurements of the free-standing electrode film produced by the mill line. The force may be exerted based at least in part on the one or more thickness measurements.

A barrel of at least one of the working rolls or at least one of the backing rolls may have a greater diameter at a lengthwise center of the barrel than at both lengthwise ends of the barrel.

The mill line may include a plurality of individually controllable heating elements arranged to heat respective lengthwise regions of a barrel of at least one of the opposing working rolls or at least one of the backing rolls. The apparatus may comprise a human machine interface for receiving user input. The plurality of heating elements may be individually controllable based at least in part on the user input. The apparatus may comprise one or more thickness sensors operable to take one or more thickness measurements of the free-standing electrode film produced by the mill line. The plurality of heating elements may be individually controllable based at least in part on the one or more thickness measurements.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows an apparatus for manufacturing an electrode for an energy storage device;

FIG. 2 shows a partial view of the apparatus with a mill line expansion module being inserted into a mill line thereof;

FIG. 3 shows an operational flow for manufacturing an electrode for an energy storage device;

FIG. 4 shows an example sub-operational flow of step 330 in FIG. 3;

FIG. 5 shows active material loading as a function of film thickness for activated dry NCM811 electrodes;

FIG. 6 shows C-rate performance of wet vs. activated dry NCM811 electrodes;

FIG. 7 shows an example press that may be used with the apparatus, along with a comparison view of working rolls without backing rolls;

FIG. 8 illustrates an example roll bending process that may be used with the press of FIG. 7;

FIG. 9A illustrates an example of roll profiling that may be used to modify the press of FIG. 7;

FIG. 9B illustrates another example of roll profiling that may be used to modify the press of FIG. 7; and

FIG. 10 illustrates an example heating process that may be used with the press of FIG. 7.

### DETAILED DESCRIPTION

The present disclosure encompasses various embodiments of apparatuses for manufacturing electrodes for energy storage devices as well as manufacturing methods and intermediate and final products thereof. The detailed description set forth below in connection with the appended drawings is intended as a description of several currently contemplated embodiments and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

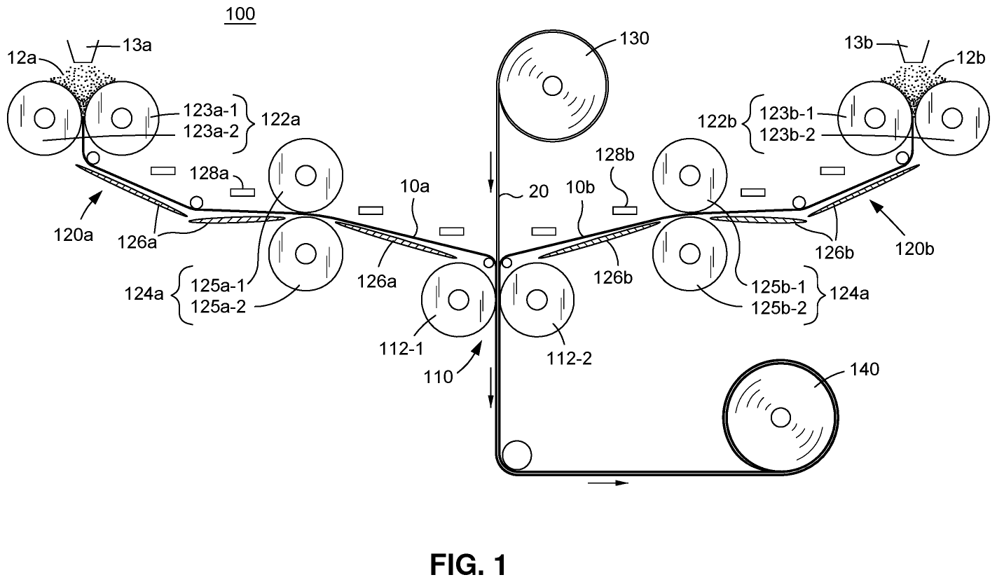

FIG. 1 shows an apparatus 100 for manufacturing an electrode for an energy storage device such as a Li-ion battery, solid state battery, Li-ion capacitor (LIC), or ultracapacitor. The finished energy storage device may comprise one or more electrodes assembled by laminating a first free-standing electrode film 10a and a second free-standing electrode film 10b on opposite sides of a current collector 20 such as an aluminum metal sheet in the case of cathode electrode film(s) 10a, 10b or a copper metal sheet in the case of anode electrode film(s) 10a, 10b. The apparatus 100 may comprise at least one laminator 110 for simultaneously laminating the two free-standing electrode films 10a, 10b on opposite sides of the current collector 20. The laminator 110 may have working rolls 112-1, 112-2 arranged horizontally as shown, for example, but a vertical arrangement is also contemplated. The apparatus 100 may further comprise a pair of mill lines 120a, 120b (e.g., arranged as wings of the apparatus 100) operable to produce, respectively, the two free-standing electrode films 10a, 10b and feed them simultaneously to the laminator 110. The laminator 110 may then laminate the two free-standing electrode films 10a, 10b on either side of the current collector 20 as it is unwound from a first spool 130 and subsequently wound, together with the laminated films 10a, 10b on a second spool 140 (or alternatively sent to a cutting machine). Owing to the apparatus 100 and associated methods described herein, efficient handling of the free-standing electrode films 10a, 10b may be possible, even in the case of relatively thin free-standing electrode films 10a, 10b (e.g., less than 200 μm or less than 100 μm) and/or those formed from less flexible materials (e.g., battery active materials) such as NCM, NCA, LFP, graphite, and silicon, allowing for the production of a wide variety of energy storage devices for different purposes. In some embodiments, as described in more detail below, the apparatus 100 may have a modular design, allowing the same apparatus 100 to be used to efficiently manufacture electrodes for energy storage devices having different specifications as needed.

Depending on the particular application of the energy storage device to be manufactured, the dry powder mixtures 12a, 12b used to produce the free-standing electrode films 10a, 10b may have various formulations and may be produced according to various methods. Some exemplary dry powder formulations and methods that may be used to produce the dry powder mixtures 12a, 12b are described in the inventor's own patents and patent applications, including U.S. Pat. No. 9,236,599, entitled “Low Cost High Performance Electrode for Energy Storage Devices and Systems and Method of Making Same,” U.S. Pat. No. 10,069,131, entitled “Electrode for Energy Storage Devices and Method of Making Same,” U.S. Patent Application Pub. No. 2020/0388822 (now U.S. Pat. No. 11,616,218), entitled “Dry Electrode Manufacture by Temperature Activation Method,” U.S. Patent Application Pub. No. 2022/0077453 (now U.S. Pat. No. 11,508,956), entitled “Dry Electrode Manufacture with Lubricated Active Material Mixture,” U.S. Patent Application Pub. No. 2022/0158150, entitled “Dry Electrode Manufacture with Composite Binder,” U.S. Patent Application Pub. Nos. 2023/0108113 and 2023/0106377, both entitled “Dry Electrode Manufacture for Solid State Energy Storage Devices,” and U.S. patent application Ser. No. 18/103,126, entitled “Free-Standing Electrode Film Containing Recycled Materials,” the entire disclosure of each of which is wholly incorporated by reference herein. Typically, since the first and second free-standing electrode films 10a, 10b will be disposed by the apparatus 100 on the same current collector 20, both dry powder mixtures 12a, 12b will be formulated and produced in the same way (and thus in practice may be divided from the same production batch, for example).

Each of the mill lines 120a, 120b may comprise at least one first press 122a, 122b for pressing one of the powder mixtures 12a, 12b into a respective free-standing electrode film 10a, 10b. Referring to the mill line 120a by way of example (equivalent reference numbers using the letter “b” instead of “a” in the case of the mill line 120b), the first press 122a may include working rolls 123a-1, 123a-2 arranged horizontally as shown, such that the powder mixture 12a may be poured on top of the working rolls 123a-1, 123a-2 (from a powder feed conveyor 13a, for example) and emerge from the bottom thereof in the form of a continuous film having been subjected to pressure and heat by the working rolls 123a-1, 123a-2. To this end, the working rolls 123a-1, 123a-2 of the first press 122a may have elevated surface temperatures (e.g., greater than 70° C.). Advantageously, the working rolls 123a-1, 123a-2 may be controlled to rotate at the same speed as each other, with the gap between the working rolls 123a-1, 123a-2 being freely adjustable to affect the film density and porosity as desired for the particular material and application. In this regard, it is noted that it may be unnecessary for the first press 122a to produce a shear effect by the operation of working rolls 123a-1, 123a-2 having different speeds, especially in a case where the powder mixture 12a has been produced by one of the exemplary methodologies referred to above in which the powder mixture 12a has already been subjected to a shear force using a jet mill, for example.

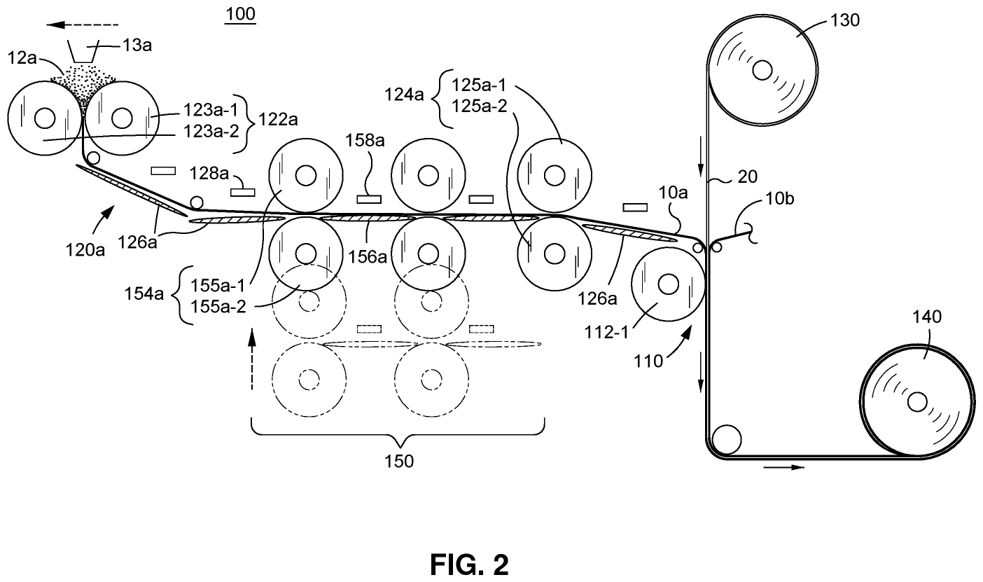

Each of the mill lines 120a, 120b may further comprise at least one second press 124a, 124b for reducing the thickness of the respective free-standing electrode film 10a, 10b. Referring again to the mill line 120a by way of example, the second press 124a may include working rolls 125a-1, 125a-2 that are typically (though not necessarily) arranged vertically as shown. Like the working rolls 123a-1, 123a-2 of the first press 122a, the working rolls 125a-1, 125a-2 of the second press 124a may have elevated surface temperatures (e.g., greater than 70° C.) and may be controlled to rotate at the same speed as each other, with the gap between the working rolls 125a-1, 125a-2 being freely adjustable as desired. While only a single second press 124a is shown in FIG. 1, it is contemplated that any number of second presses 124a may be provided in a row, each one further reducing the thickness of the free-standing electrode film 10a through the application of heat and pressure (e.g., with the working rolls 125a-1, 125a-2 in contact with the film 10a and the gap between the working rolls 125a-1, 125a-2 successively becoming smaller for each second press 124a) until the desired film thickness is achieved for the given application. As described in more detail below in relation to the modular aspects of the apparatus 100, it may be most advantageous for each mill line 120a, 120b to include only a single second press 124a, 124b as part of the base construction of the apparatus 100 (with the apparatus 100 being expandable using one or more mill line expansion modules 150 as shown in FIG. 2) in order to best accommodate production runs that use only a single second press 124a, 124b in each mill line 120a, 120b, such as when producing relatively thick free-standing electrode films 10a, 10b. Along the same lines, it is contemplated that the base construction of each mill line 120a, 120b may include only the one or more first presses 122a, 122b, without any second presses 124a, 124b whatsoever in some implementations.

As newer energy storage device applications begin to require electrodes made from thinner free-standing electrode films 10a, 10b, and as the possibilities for active materials grow to encompass materials that produce less flexible and more breakable free-standing electrode films 10a, 10b, conventional roll-to-roll processing apparatuses and methods may be inadequate for handling the free-standing electrode films 10a, 10b without breakage. Therefore, in order to better support each free-standing electrode film 10a, 10b as it passes through the respective mill line 120a, 120b toward the laminator 110 (after which the free-standing electrode film 10a, 10b will be adequately supported by the sturdier current collector 20 and will no longer be free-standing), it is contemplated that each mill line 120a, 120b may comprise one or more conveyors 126a, 126b such as vacuum conveyors, for example. Referring to the mill line 120a by way of example, the one or more conveyors 126a may be arranged to support the free-standing electrode film 10a at any of various positions including, for example, i) as the free-standing electrode film 10a is fed from the second press(es) 124a of the mill line 120a to the laminator 110, ii) as the free-standing electrode film 10a is fed from a first of the second press(es) 124a to a second of the second press(es) 124a, and/or iii) as the free-standing electrode film 10a is fed from the first press(es) 122a to the second press(es) 124a. The speed of each conveyor 126a may be controlled in accordance with the thickness and tension of the free-standing electrode film 10a at each particular position, which may be determined by the arrangement of the presses 122a, 124a and roller speeds thereof, as well as that of the downstream laminator 110. For example, the speed(s) of the conveyor(s) 126a between the second press(es) 124a and the laminator 110 may be controlled to be different from the speed(s) of the conveyor(s) between successive second press(es) 124a, which may in turn be different from the speed(s) of the conveyor(s) between the first press(es) 122a and the second press(es) 124a. In practice, the speeds of the conveyor(s) 126a may be controlled in a cascading fashion, with a final laminator speed 110 determining the speeds at each upstream position of each mill line 120a, 120b. As feedback to the control process, each mill line 120a, 120b may comprise one or more tension sensors 128a, 128b arranged to measure a tension on the free-standing electrode film 10a, 10b. Load cells or other proximity sensors may be employed to maintain the optimum tension control by adjusting the conveyor and working roll rotation speeds. The variable speed(s) and/or speed ratio(s) of the one or more conveyor(s) 126a, 126b may be controlled so that speed(s) between presses are appropriately matched based on the measured tension(s) using any of various algorithms including machine learning models, allowing the lamination speed to remain constant and preventing rupture of the films 10a, 10b.

FIG. 2 shows a partial view of the apparatus 100 with a mill line expansion module 150 being inserted into a mill line 120a thereof. The mill line expansion module 150 may comprise at least one additional second press 154a for reducing the thickness of the respective free-standing electrode film 10a, 10b (in this case the electrode film 10a as illustrated). As shown, for example, the mill line 120a of the base apparatus 100 may include a single second press 124a and the mill line expansion module 150 may introduce one or more additional second presses 154a (two additional second presses 154a as illustrated). The additional second press(es) 154a may be insertable into the mill line 120a just prior to the second press 124a of the base apparatus 100, for example. (It is noted that, in a case where the mill line 120a includes no second presses 124a, the additional second press(es) 154a introduced by the mill line expansion module 150 may be the only thickness-reducing presses of the apparatus 100.) The dashed arrows in FIG. 2 show one possible insertion procedure in which the first press 122a is moved farther away from the laminator 110 (toward the left in FIG. 2) and the mill line expansion module 150 is slotted into the space created thereby (upward in FIG. 2), with phantom lines illustrating the mill line expansion module 150 prior to being inserted into the mill line 120a.

Like each second press 124a, 124b of the respective mill lines 120a of the base apparatus 100, each additional second press 154a introduced by a mill line expansion module 150 may include working rolls 155a-1, 155a-2 that are typically (though not necessarily) arranged vertically as shown. The working rolls 155a-1, 155a-2 of each additional second press 154a may have elevated surface temperatures (e.g., greater than 70° C.) and may be controlled to rotate at the same speed as each other, with the gap between the working rolls 155a-1, 155a-2 being freely adjustable as desired. It is contemplated that the mill line expansion module 150 may further include one or more additional conveyors 156a that are insertable between conveyors 126a of the mill line 120a as shown. The mill line expansion module 150 may further include one or more additional tension sensors 158a that are arranged to measure a tension on the free-standing electrode film 10a as it passes through (e.g., before or after) the additional second press(es) 154a of the mill line expansion module 150. The additional conveyor(s) 156a and additional tension sensor(s) 158a may be connected to the same speed control system as the conveyor(s) 126a and tension sensor(s) 128a of the base apparatus 100. It is noted that the mill line expansion module 150 may be symmetrically designed for insertion in the mill line 120b rather than the mill line 120a as illustrated (and equivalent reference numbers using the letter “b” instead of “a” may be referred to in this case, though not separately illustrated).

By virtue of the mill line expansion module 150, the same apparatus 100 may be readily customizable for different production runs having different specifications for the energy storage device to be produced. A manufacturer of energy storage devices that are made using relatively thick free-standing electrode films 10a, 10b may use only the base apparatus 100 with no mill line expansion modules 150 or with only a single mill line expansion module 150 in each mill line 120a, 120b, while a manufacturer who needs to produce thinner free-standing electrode films 10a, may insert several mill line expansion modules 150 (or, in some cases, mill line expansion modules 150 having a greater number of additional second presses 154a, 154b, though a standardized mill line expansion module 150 may be preferable). The same apparatus 100 can satisfy the needs of both manufacturers, allowing for the efficient production and use of the apparatus 100 and mill line expansion modules 150. Without the modular design, it would be necessary either i) to market and produce a variety of different size apparatuses 100 or to custom-build the apparatus 100 for each manufacturer (with associated inefficiencies and costs in either case) or ii) to produce only the largest possible apparatus 100 with the highest possible number of second presses 124a, 124b that might be used. In the latter case, the apparatus 100 may become unreasonably expensive for a manufacturer who does not need to reduce the thickness of the free-standing electrode film 10a, 10b so much, both in terms of the purchase price but also in terms of maintenance and required personnel to oversee and run such a large apparatus 100. Moreover, any unused second presses 124a, 124b in a given run increase the risk of damaging the free-standing electrode film 10a, 10b as it is en route to the laminator 110, decreasing the yield of the run and making a large number of unused second presses 124a, 124b a liability for the manufacturer.

Along the same lines, a manufacturer who produces a variety of different products is better served by the modular apparatus 100, which may allow the manufacturer to increase or decrease the number of presses as need by attaching or detaching mill line expansion modules 150. The apparatus 100 may be used for some runs with several mill line expansion modules 150 and for other runs with few or none, decreasing the associated costs of these runs in terms of personnel and yield. As another possibility, it is contemplated that a mill line expansion module 150 may be used as a replacement in the event that the press(es) 154a, 154b of another mill line expansion module 150 need repair. Rather than shut down the entire manufacturing line pending the repair of the damaged press stations, the mill line expansion module 150 where the problem is occurring can simply be swapped for a fresh mill line expansion module 150. In this way, the manufacturing process can continue after only a moment's delay. The damaged mill line expansion module 150 can be repaired, without significantly interrupting production, even as the manufacturing process is ongoing.

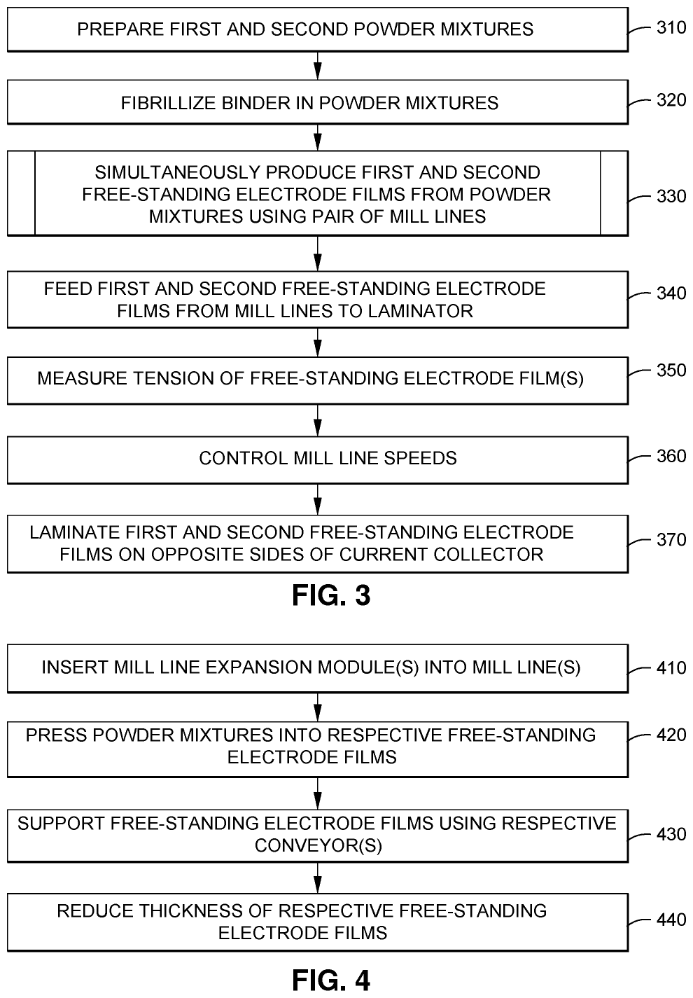

FIG. 3 shows an operational flow for manufacturing an electrode for an energy storage device in accordance with the disclosed innovations. In particular, the operational flow of FIG. 3 may be performed using the apparatus 100 described in relation to FIGS. 1 and 2. The operational flow may begin with preparing first and second power mixtures 12a, 12b (step 310) and fibrillizing a binder contained in the powder mixtures 12a, 12b (step 320). For example, as described in the inventor's own patents and patent applications, incorporated by reference above, the powder mixture 12a, 12b may include, in addition to at least one type of electrode active material (e.g. a lithium metal oxide in the case of a cathode or graphite or silicon in the case of an anode), at least one type of fibrillizable binder such as such as polytetrafluoroethylne (PTFE), polyvinylpyrrolidone (PVP), polyvinylidene fluoride (PVDF), polyethylene oxide (PEO), polyethylene (PE), or carboxymethylcellulose (CMC), or a combination of the above binders or co-polymers. Fibrillizable binders may be characterized by their soft, pliable consistency and, in particular, by their ability to stretch, becoming longer and finer to take on a fibrous status when they undergo shear force. Owing to the use of one or more fibrillizable binders, which may further be chemically or thermally activated to increase its flexibility as described in the inventor's patents and patent applications, the powder mixture may be pressed into a free-standing film without breakage and without excessive use of toxic and expensive solvents such as N-Methylpyrrolidone (NMP). The binder may be fibrillized by subjecting the powder mixture 12a, 12b to a shear force, e.g., using a kitchen blender, industrial blender, coffee grinder, grain mill grinder, high speed mixer, cyclone paint mixer, rotary mixer, planetary mixer, high shear disperser such as Admix Rotosolver, high shear granulator such as Diosna P1-6, high shear micronizer such as a jet mill, high shear emulsifier, high shear mixer such as Ross Megashear mixer, or acoustical mixer. As noted above, the powder mixtures 12a, 12b may in practice be divided from the same production batch. In this regard, it should be noted that steps 310 and 320 may be combined, or, equivalently, step 310 may encompass preparing the first and second powder mixtures 12a, 12b without separating them (i.e., preparing enough powder mixture for two mill lines 120a, 120b).

In the case of producing an electrode for a solid state battery, the powder mixture 12a, 12b may further include at least one dry electrolyte powder as described in the inventor's own U.S. Patent Application Pub. Nos. 2023/0108113 and 2023/0106377, incorporated by reference above. As disclosed therein, example dry electrolyte powders may include, for example, materials that are primarily (e.g. 80-100% by weight) a ceramic such as a garnet-structure oxide, for example, lithium lanthanum zirconium oxide (LLZO) with various dopants (e.g. Li_{6.5}La₃Zr₂O₁₂ or Li₇La₃Zr₂O₁₂), lithium lanthanum zirconium tantalum oxide (LLZTO) (e.g. Li_{6.4}La₃Z_{1.4}Ta_{0.6}O₁₂), lithium lanthanum zirconium niobium oxide (LLZNbO) (e.g. Li_{6.5}La₃Zr_{1.5}Nb_{0.5}O₁₂), lithium lanthanum zirconium tungsten oxide (LLZWO) (e.g. Li_{6.3}La₃Zr_{1.65}W_{0.35}O₁₂), a perovskite-structure oxide, for example, lithium lanthanum titanate (LLTO) (e.g. Li_{0.5}La_{0.5}TiO₃, Li_{0.34}La_{0.56}TiO₃, or Li_{0.29}La_{0.57}TiO₃) or lithium aluminum titanium phosphate (LATP) (e.g. Li_{1.4}Al_{0.4}Ti_{1.6}(PO₄)₃), a lithium super ionic conductor Li₂₊₂ₓZn₁₋ₓGeO₄ (LISICON), for example, lithium aluminum titanium phosphate (LATP) (e.g. Li_{1.3}Al_{0.3}Ti_{1.7} (PO₄)₃), lithium aluminum germanium phosphate (LAG or sodium super ionic conductor i.e. NASICON-type LAGP) (e.g. Li_{1.5}Al_{0.5}Ge_{1.5}(PO₄)₃ or Li_{1.5}Al_{0.5}Ge_{1.5}P₃O₁₂), or a phosphate, for example, lithium titanium phosphate (LTPO) (e.g. LiTi₂(PO₄)₃), lithium germanium phosphate (LGPO) (e.g. LiGe₂(PO₄)₃), lithium phosphate (LPO) (e.g. gamma-Li₃PO₄ or Li₇P₃O₁₁), or lithium phosphorus oxynitride (LiPON). As another example, the dry electrolyte powder 119 may be primarily (e.g. 80-100% by weight) a polymer such as PEO, PEO-PTFE, PEO-LiTFSi, PEO-LiTFSi/LLZO, PEO-LiClO₄, PEO-LiClO₄/LLZO, poly(3,4-ethylenedioxythiophene) polystyrene sulfonate (PEDOT:PSS), polyphenylene oxide (PPO), polyethylene glycol (PEG), a polyether-based polymer, a polyester-based polymer, a nitril-based polymer, a polysiloxane-based polymer, polyurethane, poly-(bis((methoxyethoxy)ethoxy)phosphazene) (MEEP), or polyvinyl alcohol (PVA). As another example, the dry electrolyte powder 119 may be primarily (e.g. 80-100% by weight) a sulfide such as lithium sulfide (LS) (e.g. Li₂S), glassy lithium sulfide phosphorus sulfide (LSPS) (e.g. Li₂S—P₂S₅), glassy lithium sulfide boron sulfide (LSBS) (e.g. Li₂S—B₂S₃), glassy lithium sulfide silicon sulfide (LSSiS) (e.g. Li₂S—SiS₂), lithium germanium sulfide (LGS) (e.g. Li₄GeS₄), lithium phosphorus sulfide (LPS) (e.g. Li₃PS₄ such as 75Li₂S-25P₂S₅ or Li₇P₃S₁₁ such as 70Li₂S-30P₂S₅), lithium silicon phosphorus tin sulfide (LSPTS) (e.g. Liₓ(SiSn)P_{y}S_{z}), argyridite Li₆PS₅X (X═Cl, Br) (e.g. LPSBr such as Li₆PS₅Br, LPSCl such as Li₆PS₅Cl, LPSClBr such as Li₆PS₅Cl_{0.5}Br_{0.5}, or LSiPSCl such as Li_{9.54}Si_{1.74}P_{1.44}S_{11.7}Cl_{0.3}), or thio-LISICON (e.g. LGPS such as Li₁₀GePS₁₂).

Preferably, the powder mixture 12a, 12b may further include at least one additive containing solvent in order to chemically activate the fibrillizable binder to improve its adhesion strength (e.g., allowing it to soften further and become more able to stretch without breaking). In this regard, a highly vaporizable solvent may be included in the powder mixture 12a, 12b as described in U.S. Pat. Nos. 9,236,599, and 10,069,131, incorporated by reference above. The solvent may have a relatively low boiling point of less than 180° C., less than 130° C., or less than 100° C. such that minimal or no drying process is necessary to remove the solvent afterwards (unlike slurry-based and extrusion processes for producing electrodes). Example solvents may include hydrocarbons (e.g., hexane, benzene, toluene), acetates (e.g., methyl acetate, ethyl acetate), alcohols (e.g., propanol, methanol, ethanol, isopropyl alcohol, butanol), glycols, acetone, dimethyl carbonate (DMC), diethyl carbonate (DEC), and tetrachloroethylene. Unlike in the case of slurry-based and extrusion methods, the amount of the solvent may generally be very low, with the first mixture having total solid contents greater than 95% by weight, for example. The additive containing the solvent may in some cases comprise an additive solution or conductive paste containing a polymer additive mixed with a liquid carrier as described in U.S. Pat. No. 11,508,956, incorporated by reference above.

The operational flow of FIG. 4 may continue with simultaneously producing first and second free-standing electrode films 10a, 10b from the powder mixtures 12a, 12b using a pair of mill lines 120a, 120b such as those described in relation to FIGS. 1 and 2 (step 330). FIG. 4 shows an example sub-operational flow of this step, which may begin with inserting one or more mill line expansion modules 150 into the mill lines 120a, 120b as needed to achieve the particular specifications (e.g., thickness, density and porosity, and mechanical strength, such as film tensile strength and elongation) of each free-standing electrode film 10a, 10b for the electrode to be manufactured (step 410). With the mill lines 120a, 120b of the apparatus 100 having been expanded accordingly, the sub-operational flow of FIG. 4 may proceed with pressing the powder mixtures 12a, 12b into respective free-standing electrode films 10a, 10b using respective first presses 122a, 122b (step 420), supporting the free-standing electrode films 10a, 10b as they pass through the mill lines 120a, 120b using conveyors 126a, 126b (step 430), and reducing the thicknesses of the respective free-standing electrode films 10a, 10b using any second press(es) 124a, 124b that are part of the base apparatus 100 plus any additional second press(es) 154a, 154b that are added by mill line expansion modules 150 (step 440). Owing to the innovative design of the apparatus 100, the two free-standing electrode films 10a, 10b may be produced and appropriately thinned simultaneously, allowing for the subsequent feeding to the laminator 110 and simultaneous lamination on the current collector 20.

In particular, referring back to FIG. 3, the operational flow may proceed with feeding the first and second free-standing electrode films 10a, 10b from the respective mill lines 120a, 120b to the laminator 110 (step 340). Of particular note, this may be done while continuing to support the free-standing electrode films 10a, 10b on appropriately speed-controlled conveyors 126a, 126b, thus minimizing the possibility of breakage at a position where the films 10a, 10b are at their thinnest, lowest break strength, or most fragile. In this regard, the operational flow may further include measuring the tension of each free-standing electrode film 10a, 10b at one or more positions using tension sensors 128a, 128b, 158a, 158b (step 350) and controlling the mill line speeds accordingly as described above, in particular, by adjusting the speeds of conveyors 126a, 126b, 156a, 156b (step 360) and/or the rotation speed(s) of the working rolls. As the free-standing electrode films 10a, 10b exit the respective mill lines 120a, 120b, the laminator 110 may laminate them on opposite sides of the current collector 20 (step 370), which may in some cases be pre-treated with chemical etching, coated with a conductive binder layer, or both. The finished electrode may be wound on the second spool 140 or cut by a cutting machine. By simultaneously producing the free-standing electrode films 10a, 10b using the pair of mill lines 120a, 120b and feeding the free-standing electrode films 10a, 10b to the laminator 110 in a continuous process (especially where the mill lines 120a, 120b are arranged as upstream wings of a distinct central press serving as the laminator 110), the disclosed manufacturing process may proceed at more than double the speed of processes that use the same single mill line to produce both films. In such processes, a separate laminator machine must be loaded with two rolls of the produced active material film and one roll of current collector between formation of the films and lamination on the current collector, such that the final electrode lamination speed is at most half of the mill line speed. The disclosed apparatus 100 is capable of twice the speed of such multi-step processes.

Exemplary data of free-standing electrode films 10a, 10b made from three different active materials is provided in Table 1, below.

TABLE 1

| | | | | Avg. | Avg. | | Avg. | Avg. |
|---|---|---|---|---|---|---|---|---|
| | Film | Number | Avg. | Peak | Tensile | Avg. | Film | Film |
| | Group | of | Thickness | Force | Strength | Elongation | Density | Porosity |
| | (μm) | Presses | (μm) | (gf) | (kPa) | (%) | (g/cc) | (%) |
| NCM | 65 | 15 | 67 | 102.7 | 600.3 | 0.50% | 3.40 | 25.9 |
| Cathode | 80 | 12 | 84 | 128.3 | 596.1 | 0.69% | 3.30 | 28.0 |
| | 100 | 10 | 105 | 157.3 | 590.3 | 0.85% | 3.20 | 30.2 |
| | 110 | 9 | 115 | 164.3 | 560.0 | 1.33% | 3.18 | 30.7 |
| | 150 | 4 | 154 | 191.5 | 488.8 | 1.85% | 3.11 | 32.2 |
| | 180 | 3 | 186 | 222.3 | 469.5 | 1.98% | 3.06 | 33.4 |
| | 200 | 2 | 206 | 219.0 | 418.1 | 2.04% | 3.03 | 34.0 |
| | 250 | 1 | 252 | 173.0 | 268.8 | 2.59% | 3.02 | 34.2 |
| Graphite | 65 | 2 | 65 | 188.7 | 1144.7 | 0.20% | 1.71 | 23.5 |
| Anode | 80 | 2 | 85 | 128.0 | 589.9 | 0.60% | 1.60 | 28.6 |
| | 100 | 2 | 104 | 85.0 | 321.0 | 0.74% | 1.44 | 35.8 |
| | 110 | 2 | 113 | 76.7 | 266.4 | 1.03% | 1.39 | 37.8 |
| | 150 | 1 | 154 | 99.3 | 252.3 | 1.05% | 1.27 | 42.9 |
| | 200 | 1 | 202 | 47.0 | 91.3 | 1.11% | 1.24 | 44.6 |
| | 250 | 1 | 250 | 34.0 | 53.4 | 1.27% | 1.23 | 45.3 |
| | 300 | 1 | 306 | 36.0 | 46.2 | 1.40% | 1.21 | 46.0 |
| Activated | 80 | 3 | 87 | 92.7 | 418.3 | 4.49% | — | — |
| Carbon | 100 | 3 | 110 | 107.0 | 382.3 | 4.86% | — | — |
| Cathode | 110 | 3 | 118 | 105.7 | 350.3 | 6.68% | — | — |
| or Anode | 150 | 3 | 155 | 112.7 | 284.5 | 7.38% | — | — |

To produce each film group to the specified thickness (“Film Group” column), the disclosed apparatus 100 may be equipped with a suitable number of presses (“Number of Presses” column). In this regard, the number of presses shown in Table 1 (ranging from 1 to 15 for this data) should be understood to refer to all presses in a given mill line 120a, including both first press(es) 122a and second press(es) 124a, as well as any additional second press(es) 154a added using one or more mill line expansion modules 150. For example, the 250 μm NCM cathode film group (Number of Presses=1) may be produced using an apparatus 100 having a single first press 122a and no second press 124a in the mill line 120a used to produce the film, whereas the 65 μm NCM cathode film group (Number of Presses=15) may be produced with the same apparatus 100 having a single first press 122a in the mill line 120a but with fourteen additional second press(es) 154a added by mill line expansion modules 150. Table 1 shows an average thickness (“Avg. Thickness” column) that is exemplary of actual measured thicknesses corresponding to each film group in practice.

The last five columns of Table 1 show exemplary data of such films, where it can be seen that the tensile strength and film density of the film increases for thinner films and varies for different materials, while the elongation percentage (maximum machine direction elongation before breakage) and film porosity decreases for thinner films and likewise varies from material to material. The elongation percentage may be determined by a pull test (where the machine direction may refer to a draw direction in which the film is elongated by operation of the working rolls). An exemplary pull test may measure the distance pulled before breakage of a 2.5 cm wide by 10 cm long (machine direction) strip of film at an initial tension of 5 gf, for example. In particular, it is noted that the NCM cathode and graphite anode films are more difficult to work with than activated carbon films, owing to their being significantly less flexible (and thus having lower elongation percentages). As can be seen, the difficulty becomes even more pronounced for thinner films. By virtue of the apparatus 100 and associated processes described herein, it is contemplated that a wide variety of free-standing electrode films 10a, 10b can be successfully and efficiently produced on the same apparatus 100. For example, free-standing electrode films 10a, may be made of various materials including NCM, graphite, or activated carbon and may have thicknesses ranging from upwards of 300 μm down to as little as 50 μm or thinner. For each run of the apparatus 100, the mill lines 120a, 120b may be outfitted accordingly for the desired thickness or other parameters, expanded as needed by inserting mill line expansion modules 150 to increase the number of thickness-reducing presses. Moreover, owing to the innovative design of the apparatus 100, preferably including the conveyor(s) 126a, 126b, 156a, 156b to support the fragile films 10a, 10b as they pass through the mill lines 120a, 120b prior to being laminated on the current collector 20, it is contemplated that the resulting free-standing electrode films 10a, 10b may have tensile strengths ranging from 40 kPa up to greater than 100 kPa, greater than 450 kPa or even greater than 600 kPa (in the case of NCM or graphite) or, for very thin graphite anode films greater than 1100 kPa. At the same time, the machine direction elongation percentage may range from 10% down to less than 4% or even less than 2%, sometimes being as low as 0.50% or even 0.20% (in the case of NCM or graphite). The efficient handling of such fragile free-standing electrode films 10a, 10b would not be achievable without the disclosed innovations of the apparatus 100 and associated processes.

In general, it is contemplated that free-standing films having tensile strength of higher than 100 kPa and elongation percentage of less than 10% along the machine direction may require unique tension control designs to achieve high speed production processes. The use of the contemplated conveyors 126a, 126b, 156a, 156b combined with strategically placed sensors 128a, 128b (sometimes using multiple measurement methods) along the free-standing film axis may provide the necessary control to handle sensitive battery active material electrode films 10a, 10b. The difficulty in producing dry battery electrode in a free-standing film comes from the inherent brittle nature of the active materials that make conventional web handling methods impossible. By using conveyors 126a, 126b, 156a, 156b to support and transport the free-standing electrode film 10b through each press station in an automated self-threading process, the disclosed apparatus 100 and methods may overcome these difficulties.

Advantageously, the multiple press design of the apparatus 100 may allow for greater flexibility in tailoring the final electrode properties such as thickness uniformity, density, and porosity compared to other dry process electrodes produced with or without free-standing films. As shown in Table 1 above, by way of example, the film density may be selected as desired (e.g., between 3.02 g/cc and 3.40 g/cc for an NCM cathode or between 1.21 g/cc and 1.71 g/cc for a graphite anode) and likewise the film porosity may be selected as desired (e.g., between 25.9% and 34.2% for an NCM cathode or between 23.5% and 46.0% for a graphite anode), with low porosities (e.g., less than 32%) being achievable owing to the efficient handling of fragile free-standing electrode films 10a, 10b using the apparatus 100. In general, dry battery electrode technology requires the ability to control the loading, porosity, and uniformity of the active material layer. Other dry battery electrode processing techniques are not capable of precise tailored control of these parameters. For example, a dry spray or dry deposition electrode process that does not produce a free-standing film may be limited in the ability to control the thickness uniformity as the powder is sitting on top of the current collector and is unable to flow in multiple axes during the press. Additionally, the density and porosity may be limited by the amount of powder that can be applied to the current collector prior to pressing and the limitation of the pressing force that can be used without damaging the current collector. The disclosed innovations, by using multiple pressing stations working in tandem to produce free-standing electrode films 10a, 10b for both sides of the current collector 20 simultaneously can address all these requirements. Furthermore, having the system's thickness-reducing press stations in a modular configuration (employing a freely insertable mill line expansion module 150), rather than a fixed number of presses, allows for customization based on different material types such as anode materials or custom cathode materials.

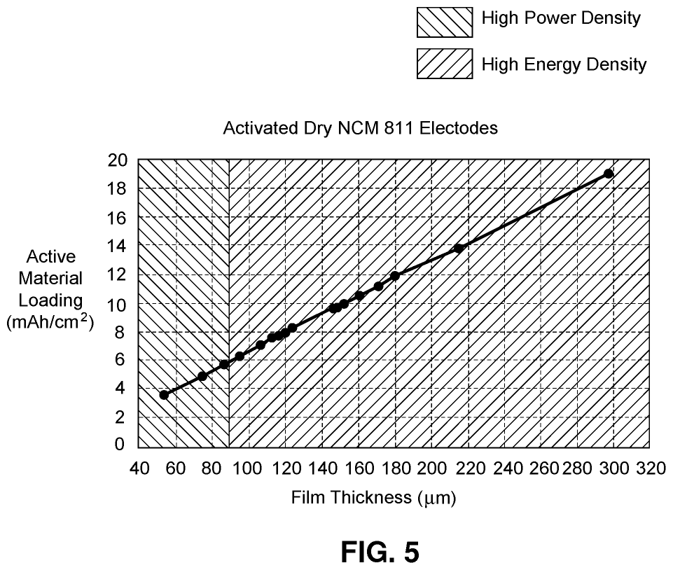

FIG. 5 shows active material loading as a function of film thickness for activated dry NCM811 electrodes (having a nickel:cobalt:manganese ratio of 8:1:1). As illustrated, the degree of active material loading, represented as discharge capacity per unit area (mAh/cm²), may be determined, at least in part, by the film thickness (μm). Electrodes made from thinner films (e.g., below 90 μm) may exhibit discharge capacity per unit area of less than 6 mAh/cm², for example, which may typically be suitable as a drop-in technology for high power density application such as electric vehicles (EV). Meanwhile, electrodes made from thicker films (e.g., above 80 μm) may exhibit discharge capacity per unit area of greater than 6 mAh/cm², for example, which may typically be suitable for high energy density applications such as energy storage systems (ESS). Using conventional methods, such wide-ranging applications require different manufacturing equipment that is specialized for each application, resulting in great cost and inefficiency to the manufacturer. In contrast, embodiments of the apparatus 100 described herein may advantageously allow a wide variety of electrodes to be produced using the same apparatus 100, with the thicknesses of the free-standing films 10a, 10b and other parameters being freely selectable by modifying the number of thickness-reducing presses 124a, 124b, 154a, 154b using mill line expansion modules 150, for example, allowing for the manufacture of batteries for EV, ESS, and other applications at relatively low cost and with great efficiency.

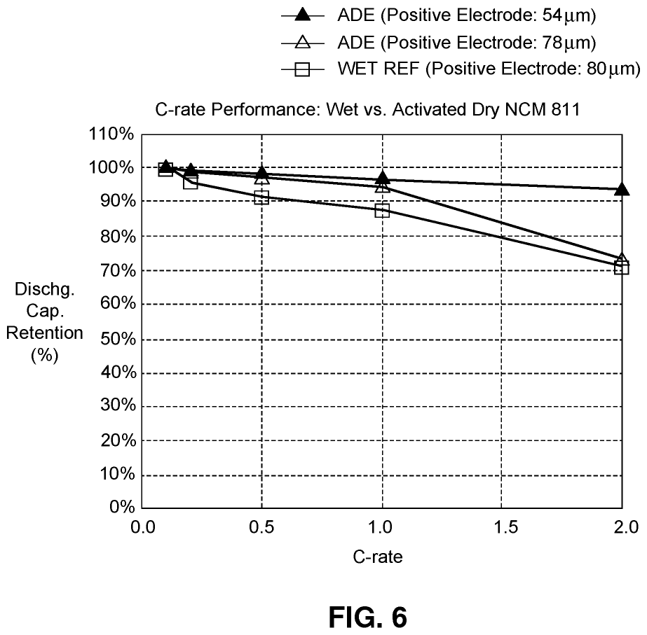

FIG. 6 shows C-rate performance of wet vs. activated dry NCM811 electrodes (ADE). Activated dry electrodes may refer to those produced by activated dry methods as described herein and incorporated by reference, for example, whereas contemplated wet electrodes (WET REF) may be made by conventional slurry coating methods, for example. As can be seen, the performance of an electrode at a given C-rate, represented as discharge capacity retention (%), may depend on the thickness of the activated dry electrode film, with thinner ADE films (e.g., 54 μm) exhibiting better performance at higher C-rates than thicker ADE films (e.g., 78 μm) or wet electrodes. Thus, depending on the desired C-rate of the battery to be produced, a manufacturer may wish to be able to freely adjust the thickness of the electrode film, something that is not easy to do and often not possible using conventional manufacturing equipment. By virtue of embodiments of the apparatus 100 described herein, however, the thicknesses of the free-standing films 10a, 10b may be customizable as needed for the desired C-rate or other parameter of the energy storage device to be produced.

In the above examples, it is described how the apparatus 100 may be used to produce a double-sided electrode by simultaneously running both mill lines 120a, 120b and laminating two free-standing electrode films 10a, 10b on opposite sides of a current collector 20. However, the processes described herein are not intended to be limited to the use of the apparatus 100 in this way. For example, in order to produce a single-sided electrode, a single mill line 120a of the apparatus 100 may be run, with the laminator 110 laminating only a single free-standing electrode film 10a on the current collector 20. It should also be recognized that any of the working rolls 112-1, 112-2 of the laminator 110, the working rolls 123a-1, 123a-2, 125a-1, 125a-2 of the mill line 120a, the working rolls 155a-1, 155a-2 of the mill line expansion module 150, and any corresponding working rolls provided in relation to the mill line 120b may be supported by one or more backing rolls such as a 4HI, 6HI, or cluster roll configuration.

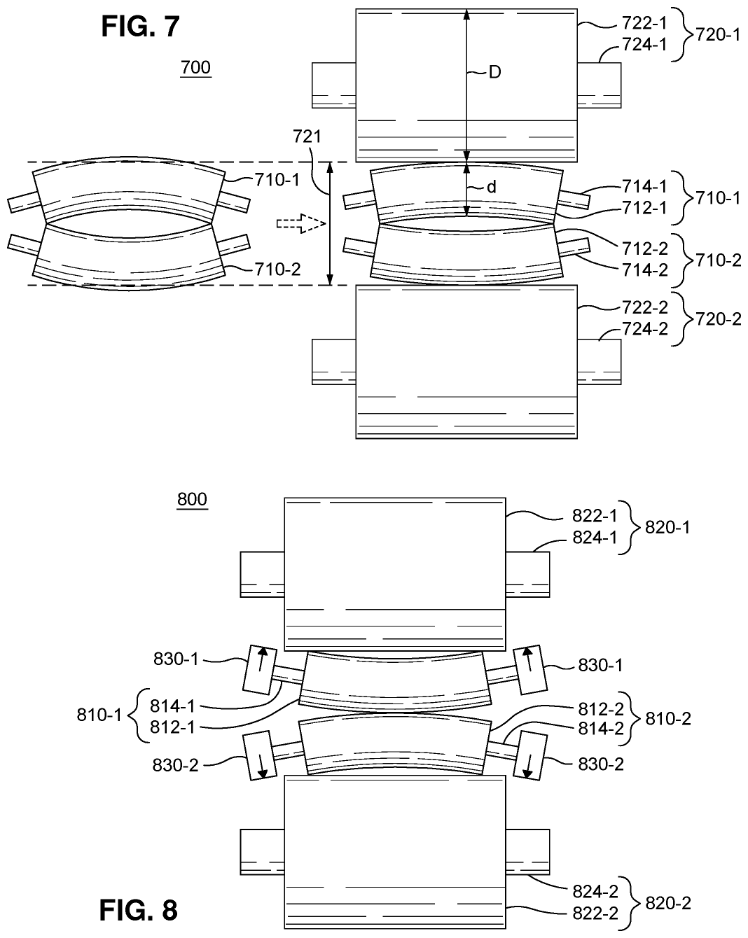

FIG. 7 shows an example press 700 that may be used as part of the apparatus 100. The press 700 may be used as a first press 122a, 122b or as a second press 124a, 124b and may be included in a mill line expansion module 150 as an additional second press 154a, 154b, for example. The press 700 may also be used in other mill lines of different apparatuses other than those disclosed herein. The press 700 may include a pair of opposing working rolls 710-1, 710-2 (collectively, 710) and a backing roll 720-1, 720-2 (collectively, 720) associated with each working roll 710. Each working roll 710-1, 710-2 and backing roll 720-1, 720-2 may comprise a respective barrel 712-1, 712-2, 722-1, 722-2 defining the active surface or face of the roll where the rolling takes place and a respective journal 714-1, 714-2, 724-1, 724-2 that supports the barrel in the housing of a roll stand (not shown), for example. Each barrel 712-1, 712-2, 722-1, 722-2 may be characterized by a diameter as well as a length (in the machine direction), also referred to as a roll face width. The working rolls 710-1, 710-2 may have applied pressure of 0.5 kN or greater total force per linear millimeter of roll face width, such as 5.5 kN or even greater. Advantageously, such high applied pressure may be combined with a high degree of precision for the benefit of making the apparatus press 700 uniquely suited to handling materials for battery electrodes and electrodes for other energy storage devices. In this regard, it is contemplated that all rolls 710, 720 may have a total indicated runout (TIR) of less than 5 μm, even at high applied pressure. This may be achieved by precision ground rolls, precision bearing grinding, and/or an active gap control device, for example. Along the same lines, the barrels 712-1, 712-2 of the opposing working rolls 710-1, 710-2 may be separated by a roll gap that is adjustable with better than 5 μm resolution (e.g., over a 0-100 mm adjustment range), and the surface temperatures of all rolls 710, 720 may preferably be controlled to have less than +/−3° C. variation across a length of each barrel (e.g., using a plurality of cartridge heaters or a spiral baffle oil heated roll). The respective barrels may preferably be heated, e.g., to between 70° C. and 200° C. (e.g., by heating elements described herein and below). The working rolls 710-1, 710-2 may have a surface finish of ISO N8 or smoother and may have a surface cleaning system(s) such as a doctor blade, brush, or continuous solvent-based cleaning system. In the illustrated example, the press 700 is shown in a 4HI configuration in which each working roll 710 has only a single backing roll 720. However, each working roll 710 may further have at least one additional backing roll, which may be offset forward or rearward (in the machine direction) in a cluster roll configuration or may be stacked with the backing roll 720 in a 6HI configuration (in which case one of the backing rolls 720 may also be referred to as an intermediate roll).

As noted above, one of the main difficulties in producing a free-standing film 10a, 10b has been achieving uniform thickness. In this regard, it has been found by the inventor that non-uniform thickness in the transverse direction, such as crowning, may be the result of uncontrolled roll gaps between the working rolls of the mill. In particular, due to the unique material structures of the oxide compounds used as active materials for battery electrodes, the material hardness of the film 10a, 10b being produced (or the dry powder mixture 12a, 12b from which it is produced) may exceed the hardness of most steels used to construct calender rolls and other working rolls. NCM811, as an example battery active material, has a Rockwell hardness of 65 or greater. When pressing these hard active materials into a free-standing film 10a, 10b and/or reducing the thickness thereof, the forces generated in between the two working rolls by the film or powder in the press are large enough to cause the rolls to bend as shown in the left-hand side of FIG. 7, with the lengthwise centers of the working rolls 710-1, 710-2 deflecting away from each other. This results in a non-uniform gap between the two working rolls and, thus, a non-uniform thickness of the free-standing film 10a, 10b that is produced. Whereas these deflections (which are greatly exaggerated in FIG. 7) may be considered inconsequential in most roll pressing tasks, they may be enough to cause the film 10a, 10b to be out of tolerance for producing a battery cell.

In order to help prevent the roll deflection shown in the left-hand side of FIG. 7 and improve the thickness uniformity of the film 10a, 10b being produced, the press 700 may advantageously include the backing rolls 720 as shown in the right-hand side of FIG. 7. As represented in FIG. 7, the backing rolls 720 may present an opposing surface that counters the force of deflection acting on the working rolls 710 by the film 10a, 10b or powder mixture 12a, 12b. To this end, the backing rolls 720, which may be friction driven by the working rolls 710 rather than being actively driven, may be larger than the working rolls 710 in order to present a greater counterforce and act as a constraint on roll deflection. For example, the barrel 722-1, 722-2 (collectively, 722) of each backing roll 720 (or at least one of the backing rolls 720) may preferably have a diameter D that is at least 1.5 times the diameter d of the barrel 712-1, 712-2 (collectively, 712) of the associated working roll 710. As a result, the deflection of the working rolls 710 may be limited as the working rolls 710 are pushed against the larger backing rolls 720, as illustrated in the right-hand side of FIG. 7. As can be seen, if a roll gap 721 is defined between the backing rolls 720 during deflection of the working rolls 710 as represented in the right-hand side of FIG. 7, the same working rolls 710 would deflect beyond the roll gap 721 without the benefit of the backing rolls 720 as represented in the left-hand side of FIG. 7. In this way, the thickness uniformity of the free-standing film 10a, 10b produced by the press 700 may be controlled to be within tolerance.

FIGS. 8, 9, and 10 respectively illustrate three additional measures that may be taken to further limit the roll deflection described above. Referring first to FIG. 8, another example press 800 is shown that may be used as part of the apparatus 100. The press 800 may be the same as the press 700 and may include working rolls 810-1, 810-2 (collectively, working rolls 810) and backing rolls 820-1, 820-2 (collectively, backing rolls 820) that are the same as the working rolls 710 and backing rolls 720 described in relation to FIG. 7 and may comprise barrels 812-1, 812-2, 822-1, 822-2 and journals 814-1, 814-2, 824-1, 824-2 that are the same as the barrels 712-1, 712-2, 722-1, 722-2 and journals 714-1, 714-2, 724-1, 724-2, except that the press 800 may further include one or more actuators 830-1, 830-2 (collectively, actuators 830) arranged to exert a force that counters the roll deflection of the working rolls 810 and/or the (usually less severe) roll deflection of the backing rolls 820. By way of example, the illustrated pair of actuators 830-1 is arranged to exert a force on the journal 814-1 of the working roll 810-1, the force acting so as to bend a lengthwise center of the barrel 812-1 of the working roll 810-1 toward the other working roll 810-2. Likewise, the illustrated pair of actuators 830-2 is arranged to exert a force on the journal 814-2 of the working roll 810-2, the force acting so as to bend a lengthwise center of the barrel 812-2 of the working roll 810-2 toward the other working roll 810-1. As shown, the lengthwise centers of the barrels 812-1, 812-2 may thus be made to bow out toward each other (exaggerated in FIG. 8), countering the deflection of each barrel 812-1, 812-2 in the opposite direction that is caused by the force of the film 10a, 10b or powder mixture 12a, 12b. While not separately illustrated, the actuators 830 may similarly be arranged to exert forces on respective journals 824-1, 824-2 of the backing rolls 820, the forces acting so as to bend lengthwise centers of the barrels 822-1, 822-2 of the backing rolls 820 toward each other. In this way, roll deflection of the backing rolls 820 may similarly be countered, instead of or in addition to countering the roll deflection of the working rolls 810. Various types of actuators 830 may be used, such as hydraulic, pneumatic, or electric actuators, which may be used in conjunction with various mill block setups such as C, E, mae west, or other types of rolling mill blocks to control the deflection of the rolls 810, 820 using either open or closed loop control systems.

It is contemplated that the exertion of forces to counter the roll deflection as described above may be an active measure taken during operation of the apparatus 100, i.e., in real time. In this regard, the exact amount of force, as well as the relative amounts of force among actuators 830 acting on different rolls or among actuators 830 acting on the same roll, may be controlled based on feedback from the operation of the apparatus 100. For example, one or more thickness measurements may be taken of the free-standing electrode film 10a, 10b produced by the mill line, and the force may be exerted based on the one or more thickness measurements. By taking multiple thickness measurements of the film 10a, 10b in the transverse direction, for example, it can be seen what, if any, crowning or other deformation has occurred. The measurements may be used to adjust the force exerted by actuators 830 downstream of the film's current position (e.g., at downstream presses 800), thus aiming to correct the portion of the film 10a, 10b that was measured. Alternatively, or additionally, the measurements may be used to adjust the force exerted by actuators 830 upstream of the film's current position (the film's current position may be downstream of all of the presses 800, for example), thus aiming to finetune the processing of the presses 800 going forward. Various thickness sensors of either the contact or non-contact type may be implemented such as lasers, ultrasonic, white light, or linear variable differential transformer (LVDT) based sensors.

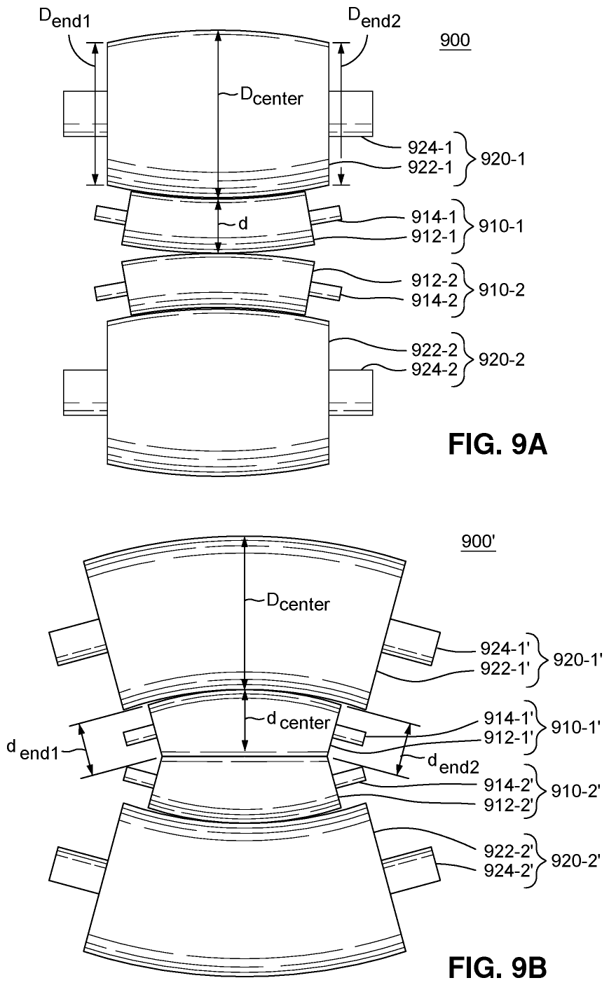

Referring now to FIG. 9A, another example press 900 is shown that may be used as part of the apparatus 100. The press 900 may be the same as the press 700 and may include working rolls 910-1, 910-2 (collectively, working rolls 910) and backing rolls 920-1, 920-2 (collectively, backing rolls 920) that are the same as the working rolls 710 and backing rolls 720 described in relation to FIG. 7 and may comprise barrels 912-1, 912-2, 922-1, 922-2 and journals 914-1, 914-2, 924-1, 924-2 that are the same as the barrels 712-1, 712-2, 722-1, 722-2 and journals 714-1, 714-2, 724-1, 724-2, except that one or more of the barrels 912-1, 912-2, 922-1, 922-2 may be ground or otherwise modified to exhibit a surface profile that compensates for the roll deflection of the working rolls 910 and/or backing rolls 920. In particular, in order to counteract the typical bowing out away from each other of the working rolls 910 at their lengthwise centers due to the force of the film 10a, 10b or powder mixture 12a, 12b acting on the working rolls 910 from between them, the barrel 922-1, 922-2 of at least one of the backing rolls 920-1, 920-2 may have a diameter D_{center} at a lengthwise center of the barrel 922-1, 922-2 that is greater than the diameter(s) D_{end1}, D_{end2} at both lengthwise ends of the barrel 922-1, 922-2. The resulting surface profile, which may be a continuous arc as shown, for example, may thus present a narrower roll gap 721 (see FIG. 7) at the center than at the ends and, accordingly, may provide the strongest backing support at the center where the tendency of the working rolls 910 to deflect apart is greatest. By profiling the backing rolls 920 in this way, taking into account the temperature and pressure that will be applied during operation, the expected deflection may be precisely countered, resulting in effectively zero net deflection.

FIG. 9B shows a variant of the press 900 and uses the same reference numbers as FIG. 9A except with the addition of the “prime” apostrophe (′). As illustrated in FIG. 9B, it is also contemplated that the barrel 912-1′, 912-2′ of at least one of the working rolls 910-1′, 910-2′ may instead or additionally be profiled, for example, to have a diameter d_{center} at a lengthwise center of the barrel 912-1′, 912-2′ that is greater than the diameter(s) d_{end1}, d_{end2} at both lengthwise ends of the barrel 912-1′, 912-2′. In this case, although the profiling is on the working roll 910′ rather than (or in addition to) being on the backing roll 920′, the result may essentially be the same because the interface between the working rolls 910′ and backing rolls 920′ similarly defines a closer, tighter contact near the center where deflection is expected to be greatest. As such, although the roll gap 721 (see FIG. 7) is not made narrower, the working rolls 910′ that fit in the roll gap 721 are equivalently made wider, resulting in a tighter fit near the center to produce a similarly advantageous effect as when profiling the backing rolls 920′.

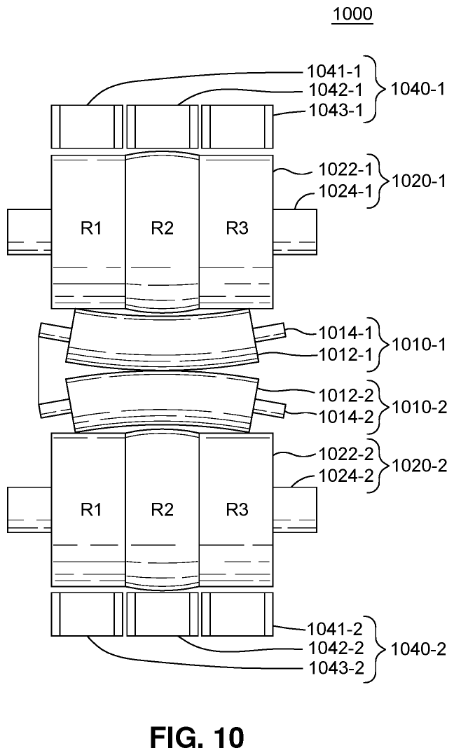

Referring now to FIG. 10, another example press 1000 is shown that may be used as part of the apparatus 100. The press 1000 may be the same as the press 700 and may include working rolls 1010-1, 1010-2 (collectively, working rolls 1010) and backing rolls 1020-1, 1020-2 (collectively, backing rolls 1020) that are the same as the working rolls 710 and backing rolls 720 described in relation to FIG. 7 and may comprise barrels 1012-1, 1012-2, 1022-1, 1022-2 and journals 1014-1, 1014-2, 1024-1, 1024-2 that are the same as the barrels 712-1, 712-2, 722-1, 722-2 and journals 714-1, 714-2, 724-1, 724-2, except that the mill line containing the press 1000 may further include heating elements 1040-1, 1040-2 that may be used to control thermal expansion of one or more of the working rolls 1010 and/or backing rolls 1020 by surface heating. In particular, as shown by way of example in FIG. 10, a plurality of heating elements 1041-1, 1042-1, 1043-1 (collectively, heating elements 1040-1) may be arranged to heat respective lengthwise regions R1, R2, R3 of the barrel 1022-1 of one of the backing rolls 1020-1. A plurality of heating elements 1041-2, 1042-2, 1043-2 (collectively, heating elements 1040-2) may similarly be arranged to heat respective lengthwise regions R1, R2, R3 of the barrel 1022-2 of another of the backing rolls 1020-2. By individually controlling the plurality of heating elements 1040-1, 1040-2, the different regions R1, R2, R3 (which could be any number of regions) may be heated differently so that some regions are subject to more significant thermal expansion than others. In this way, the surface profile may be freely adjusted and readjusted as needed, including in real time during operation of the apparatus 100. As illustrated in FIG. 10, for example, a central region R2 may be heated more than the end regions R1, R3 (e.g., by applying greater power to the central heating elements 1042-1, 1042-2), resulting in a greater amount of thermal expansion than end regions R1 and R3 and causing the central region of the barrels 1022-1, 1022-2 of the backing rolls 1020-1, 1020-2 to expand and provide greater backing support at the center where the tendency of the working rolls 1010 to deflect apart is greatest. The effect may be the same as the surface profiling described above in relation to FIGS. 9A and 9B, except with the capability of greater control and real-time adjustment. Also, in the same way as described in relation to FIG. 9B, it is contemplated that the heating elements 1040-1, 1040-2 may instead or additionally heat the working rolls 1010 rather than the backing rolls 1020, which may similarly create a closer, tighter contact between the working rolls 1010 and backing rolls 1020 near the center where deflection is expected to be greatest.

As noted, the control of the heating elements 1040-1, 1040-2 (collectively, heating elements 1040) as described above may be an active measure taken during operation of the apparatus 100, i.e., in real time. In this regard, the exact amount of heating, as well as the relative amounts of heating of the different regions R1, R2, R3, may be controlled based on feedback from the operation of the apparatus 100. For example, as described above in relation to the exertion of forces shown in FIG. 8, one or more thickness measurements may be taken of the free-standing electrode film 10a, 10b produced by the mill line, and the heating elements 1040 may be controlled based on the one or more thickness measurements. By taking multiple thickness measurements of the film 10a, 10b in the transverse direction, for example, it can be seen what, if any, crowning or other deformation has occurred. The measurements may be used to adjust the control of heating elements 1040 downstream of the film's current position (e.g., at downstream presses 1000), thus aiming to correct the portion of the film 10a, 10b that was measured. Alternatively, or additionally, the measurements may be used to adjust the control of heating elements 1040 upstream of the film's current position (the film's current position may be downstream of all of the presses 1000, for example), thus aiming to finetune the processing of the presses 1000 going forward.

It should be noted that any or all (or none) of the techniques described in relation to FIGS. 8, 9, and 10 may be combined in a single press and used for any of the presses 122a, 122b, 124a, 124b, 154a, 154b, of the apparatus 100. For example, a combination of the presses 800, 900, 1000 may be used, having rolls with or without profiled surfaces that are actively adjustable by actuators 830 and/or heating elements 1040. Along the same lines, the techniques may be combined in the same apparatus 100 but at different stages in the same mill line 120 or in different mill lines 120a, 120b. For example, pre-profiled presses 900 may be used for initial thickness reduction, while adjustable profile presses 1000 and/or presses 800 with active roll bending may be used for real-time correction in downstream thickness reduction presses. By applying these techniques to supplement the press 700 described in FIG. 7 in various combinations, the backing rolls 720, 820, 920, 1020 may be used to varying degrees of effectiveness as needed to fall within the particular thickness uniformity tolerance for the electrode film 10a, 10b being produced.

As mentioned above, the actuators 830 may control the deflection of the rolls 810, 820 using either open or closed loop control systems. By the same token, it is contemplated that the heating elements 1040 may similarly control the surface temperatures of the regions R1, R2, R3 as described above using open or closed loop control systems and, in general, that the various other parameters of the roll mill, including roll speed, roll gap, etc., be controlled using open or closed loop control systems. Closed loop control systems may involve feedback from various sensors as described herein, including thickness sensors as well as tension sensors and other sensors as described above. Algorithms and other program instructions (including in some cases machine learning models) to control the various roll mill parameters, whether based on feedback in the case of a closed loop control system or based on live user input in the case of an open loop control system, may be embodied in one or more non-transitory program storage media (e.g., hard drive, FPGA, PLA, solid state drive, RAM, flash, ROM, etc.), that store computer programs or other instructions executable by one or more processors (e.g., a CPU or GPU) or programmable circuits to control the various parameters and/or perform the various operations described herein. It is contemplated that the apparatus 100 may further include a human machine interface (HMI) that may be embodied in the program instructions and may be accessible over a network (e.g., locally or remotely) using a computer terminal or tablet, for example, in order to allow for control based on direct user input. The one or more non-transitory program storage media may in some cases reside in a cloud infrastructure (e.g., Amazon Web Services, Azure by Microsoft, Google Cloud, etc.) and/or a server system accessible via a network such as the Internet, with the computer programs or other instructions being provided to the various components of the mill line over the network. Examples of program instructions stored on a computer-readable medium may include, in addition to code executable by a processor, state information for execution by programmable circuitry such as a field-programmable gate arrays (FPGA) or programmable logic array (PLA).

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of manufacturing a free-standing electrode film for an electrode of an energy storage device, the method comprising:
providing a powder mixture of at least one electrode active material and at least one fibrillizable binder; and
feeding the powder mixture to a mill line including one or more presses to produce the free-standing electrode film, at least one of the one or more presses including a pair of opposing working rolls and a backing roll associated with each working roll.

2. The method of claim 1, wherein, for at least one of the working rolls, a barrel of the associated backing roll has a diameter that is at least 1.5 times a diameter of a barrel of the working roll.

3. The method of claim 1, further comprising exerting a force on a respective journal of one or both of the opposing working rolls, the force acting so as to bend a lengthwise center of a barrel of the working roll toward the other working roll.

4. The method of claim 3, further comprising taking one or more thickness measurements of the free-standing electrode film produced by the mill line, wherein the force is exerted based on the one or more thickness measurements.

5. The method of claim 1, further comprising exerting a force on a respective journal of one or both of the backing rolls, the force acting so as to bend a lengthwise center of a barrel of the backing roll toward the associated working roll.

6. The method of claim 5, further comprising taking one or more thickness measurements of the free-standing electrode film produced by the mill line, wherein the force is exerted based on the one or more thickness measurements.

7. The method of claim 1, wherein a barrel of at least one of the working rolls or at least one of the backing rolls has a greater diameter at a lengthwise center of the barrel than at both lengthwise ends of the barrel.

8. The method of claim 1, wherein the mill line further includes a plurality of heating elements arranged to heat respective lengthwise regions of a barrel of at least one of the opposing working rolls or at least one of the backing rolls, the method further comprising individually controlling the plurality of heating elements.

9. The method of claim 8, further comprising taking one or more thickness measurements of the free-standing electrode film produced by the mill line, wherein the plurality of heating elements are individually controlled based on the one or more thickness measurements.

10. The method of claim 1, wherein the at least one of the one or more presses further includes at least one additional backing roll associated with each working roll.

11. The method of claim 1, wherein the at least one of the one or more presses is arranged to reduce a thickness of the free-standing electrode film produced by the mill line.

12. The method of claim 1, wherein the at least one of the one or more presses is arranged to press the powder mixture into the free-standing electrode film.

13. The method of claim 1, wherein the at least one of the one or more presses is part of a mill line expansion module that is insertable into the mill line to increase the number of presses.

14. The method of claim 1, further comprising controlling a surface temperature of respective barrels of the working rolls and backing rolls to have less than +/−3° C. variation across a length of each barrel during said feeding.

15. The method of claim 14, wherein said controlling the surface temperature comprises heating the respective barrels of the working rolls and backing rolls to be between 70° C. and 200° C. during said feeding.

16. The method of claim 1, further comprising, prior to said feeding, fibrillizing the fibrillizable binder in the powder mixture by subjecting the powder mixture to a shear force.

17. The method of claim 1, wherein the powder mixture further includes at least one additive containing solvent.

18. The method of claim 1, wherein the powder mixture further includes at least one dry electrolyte powder.

19. A method of manufacturing an electrode of an energy storage device, the method comprising:
providing a powder mixture of at least one electrode active material and at least one fibrillizable binder;
feeding the powder mixture to a mill line including one or more presses to produce a free-standing electrode film, at least one of the one or more presses including a pair of opposing working rolls and a backing roll associated with each working roll; and
laminating the free-standing electrode film produced by the mill line to a current collector.

20. The method of claim 19, wherein the electrode is a solid-state battery electrode and the powder mixture further includes at least one dry electrolyte powder.

21. An apparatus for manufacturing a free-standing electrode film for an electrode of an energy storage device, the apparatus comprising a mill line including one or more presses, at least one of the one or more presses including a pair of opposing working rolls and a backing roll associated with each working roll, a barrel of at least one of the backing rolls having a diameter that is at least 1.5 times a diameter of a barrel of the associated working roll, the barrels of the opposing working rolls each having a total indicated runout (TIR) of less than 5 μm.

22. The apparatus of claim 21, wherein the barrels of the opposing working rolls are separated by a roll gap that is adjustable with better than 5 μm resolution.

23. The apparatus of claim 21, wherein the barrels of the opposing working rolls each have a surface finish of ISO N8 or smoother.

24. The apparatus of claim 21, further comprising one or more actuators operable to exert a force on a respective journal of one or both of the opposing working rolls, the force acting so as to bend a lengthwise center of a barrel of the working roll toward the other working roll.

25. The apparatus of claim 24, further comprising a human machine interface for receiving user input, wherein the force is exerted based at least in part on the user input.

26. The apparatus of claim 24, further comprising one or more thickness sensors operable to take one or more thickness measurements of the free-standing electrode film produced by the mill line, wherein the force is exerted based at least in part on the one or more thickness measurements.

27. The apparatus of claim 21, further comprising one or more actuators operable to exert a force on a respective journal of one or both of the backing rolls, the force acting so as to bend a lengthwise center of a barrel of the backing roll toward the associated working roll.

28. The apparatus of claim 27, further comprising a human machine interface for receiving user input, wherein the force is exerted based at least in part on the user input.

29. The apparatus of claim 27, further comprising one or more thickness sensors operable to take one or more thickness measurements of the free-standing electrode film produced by the mill line, wherein the force is exerted based at least in part on the one or more thickness measurements.

30. The apparatus of claim 21, wherein a barrel of at least one of the working rolls or at least one of the backing rolls has a greater diameter at a lengthwise center of the barrel than at both lengthwise ends of the barrel.

31. The apparatus of claim 21, wherein the mill line further includes a plurality of individually controllable heating elements arranged to heat respective lengthwise regions of a barrel of at least one of the opposing working rolls or at least one of the backing rolls.

32. The apparatus of claim 31, further comprising a human machine interface for receiving user input, wherein the plurality of heating elements are individually controllable based at least in part on the user input.

33. The apparatus of claim 31, further comprising one or more thickness sensors operable to take one or more thickness measurements of the free-standing electrode film produced by the mill line, wherein the plurality of heating elements are individually controllable based at least in part on the one or more thickness measurements.

34. The apparatus of claim 21, wherein the at least one of the one or more presses further includes at least one additional backing roll associated with each working roll.

35. The apparatus of claim 21, wherein the at least one of the one or more presses is arranged to reduce a thickness of the free-standing electrode film produced by the mill line.

36. The apparatus of claim 21, wherein the at least one of the one or more presses is arranged to press the powder mixture into the free-standing electrode film.

37. The apparatus of claim 21, wherein the at least one of the one or more presses is part of a mill line expansion module that is insertable into the mill line to increase the number of presses.

38. The apparatus of claim 21, wherein a surface temperature of respective barrels of the working rolls and backing rolls is controllable to have less than +/−3° C. variation across a length of each barrel.

39. The apparatus of claim 38, wherein the surface temperature is controllable to be between 70° C. and 200° C.
